(19) United States
(12) Patent Application Publication
(10) Pub. No.: US 2003/0209981 A1
(43) Pub. Date: Nov. 13, 2003

(54) Safety lamp

(76) Inventor: James W. Gibboney JR., Conyers, GA (US)

Correspondence Address: TIMOTHY J SLABOUZ, NEXSEN PRUET JACOBS & POLLARD LLC, PO DRWR 2426, COLUMBIA, SC, 29202-2426, US

(21) Appl. No.: 10/141,716

(22) Filed: May 9, 2002

(51) Int. Cl. H01K 1/42; H01K 1/50

(52) U.S. Cl. 313/580

(57) ABSTRACT

Generally, improvements are provided to the safety and other characteristics of a miniature lamp including several related to the possible reduction of the occurrence of electrocution, serious electric shock, and/or fire hazards that may be caused by the crushing of the glass envelope surrounding the internal components of the lamp and the related exposure of full-line voltage to the environment. These improvement include the locating of a bypass shunt below an insulator bead, and the use of an enlarged insulator bead that not only provides protection for the bypass shunt but also provides better filament and conductor centering within the envelope of the lamp, which not only provides a safer lamp but also a lamp having a longer lamp life. Furthermore, other embodiments describe other methods of increasing proper shunt action by minimizing the likelihood of a short circuit forming above the insulator bead.

### CROSS REFERENCE TO RELATED APPLICATIONS

Not Applicable

### STATEMENT REGARDING FEDERALLY SPONSORED RESEARCH OR DEVELOPMENT

Not applicable.

### REFERENCE TO A SEQUENCE LISTING, A TABLE, OR A COMPUTER PROGRAM LISTING COMPACT DISK APPENDIX

Not Applicable.

### BACKGROUND OF THE INVENTION

Generally, the present invention relates to lamps, and, more particularly, to safety features incorporated into miniature lamps.

Inside the glass envelope or bulb of an incandescent lamp, there is at least one light-emitting filament extending between at least two terminals and, when a voltage is applied across the terminals, the resistance to electric current running through a filament causes that filament to heat to the point where it will glow. Also, likely to be found inside the envelope or bulb is a glass bead (or some other material) insulator, which is generally used in a miniature lamp to keep the terminals spaced apart and/or to maintain the critical dimensional relationship necessary for proper shunt operation. Oftentimes, miniature lamps are used in a variety of light string sets ranging from those that are functional in nature to those that are primarily decorative. A Christmas tree light set is a common example of how these lamps are used; however, other decorative and/or functional uses are not uncommon. These lamps are fairly flexible as well, in that they are capable of being powered by either AC or DC sources, and/or being used in series or parallel-connected configurations. However, since the failure of a single lamp filament in a series configuration can cause an entire light string to become inoperative, a device, commonly referred to as a shunt, capable of bypassing a faulty lamp also may be found inside the glass envelop or bulb above the separator. An example of which can be found in the U.S. Pat. No. 5,886,458 issued to Chen Hsu.

A problem with the prior art designs, however, is that they do not adequately address the problems associated with the glass envelope or bulb becoming crushed, which is not an uncommon occurrence, and which may cause serious fire and/or electric shock hazards to develop due to the exposed terminals and/or shunt. For example, a force crushing the glass envelope could (by itself or due to the formation of glass fragments) result in the deformation of the conductors above the insulator to the extent that the prior art miniature lamp mechanical shunt will fail to become part of the series circuit. This failure may be caused by the loss of contact between the shunt and the deformed conductors, which prevents the shunt from “welding-into” the electrical circuit. When this occurs, in a prior art 120 Volt AC powered series light string, all of the lamps in the series connected light string will go out and the exposed wires will have full line-voltage of 120 VAC on them, at a current that is typically about 200 mA, which is enough to electrocute a person or pet, or, at the very least, enough to provide a very painful electric shock. Therefore, a need remains for a miniature lamp that can potentially eliminate or significantly reduce the manifestation of these hazards, yet be capable of economical and efficient manufacture and implementation

### SUMMARY OF THE INVENTION

According to its major aspects and briefly recited, the present invention is a miniature lamp incorporating safety features that are capable of potentially eliminating the hazards associated with a cracked or crushed glass envelope (or bulb) by providing a protected bypass shunt having an increased likelihood of operability after the integrity of the glass envelope has been compromised, which, in turn, minimizes the possibility of electrically related hazards while still keeping the remaining operative lamps in a series connected (or, possibly, a series-parallel connected) light string set lit.

The bypass shunt is preferably made of an oxidized metallic wire that is wrapped around the conductors connected to the filament inside of the sealed glass envelope. The present lamp is different, however, in that the bypass shunt is wrapped around the conductors beneath the glass bead (or other insulator) used to keep the conductors apart. In operation, once the filament open circuits by burning-out, or by being damaged (e.g., due to the lamp envelope being crushed) open circuit voltage, greater than the breakdown voltage that is required to activate the shunt, will be applied across the bypass shunt. This will cause the bypass shunt to electrically connect the lamp's terminals together allowing current to flow through this damaged lamp and through the other operative lamps in the light string.

A feature of the present invention is the location of the bypass shunt, which provides the advantage of reducing the possibility of shunt failure after the glass envelope surrounding the shunt is crushed. This, in turn, reduces the possibility of the exposed portions of the conductors causing a serious electric shock, electrocution, or a fire, either by direct contact with the faulty lamp or with other metallic objects (that are in contact with the faulty lamp), such as metal doors, gutters or hand rails, or by indirect contact with the faulty lamp through such sources as arcing from the exposed wires to these, or other similar, objects—even such objects as Christmas trees (i.e., Underwriters Laboratories (“UL”) has stated that arcing is the greatest cause of Christmas tree fires). Besides these advantages, the shunt is still able to bypass an open circuited filament even if the integrity of the glass envelope has not been compromised.

Another feature of the present invention lamp is the use of an insulator that is dimensioned larger than other prior art miniature lamp insulators so that it fits more closely to the lamp, which provides several advantages.

An advantage of the larger insulator is that it provides improved placement of the conductors and the filament by better centering these components inside the glass envelope. This increases lamp life by reducing the number of filament particles condensing on the inside of the glass envelope, and also keeps the exterior surface of the lamp much cooler, which may assist in preventing fires.

Another advantage associated with the location of the shunt and/or the larger insulator also includes the use of the lamp's holder. Generally, a lamp holder, which is an integral part of a light string, is used to connect a lamp to a light string, and, when a lamp is fully inserted into a lamp holder, the top of the lamp holder is generally about as high, if not higher than, the present invention lamp's insulator. Because of this, and since the lamp holder will oftentimes retain an inserted lamp after an accident in which the glass envelope of a lamp is crushed, another safety advantage is provided by the insulator and the lamp holder. Specifically, this combination effectively provides a protective shield for the area under the insulator, which offers protection to the shunt and, therefore, increases the likelihood of proper shunt operation.

Other features that are found in other embodiments of the present invention include, but are not limited to, improvements in the construction of the conductors in order to farther minimize the probability of the conductors shorting together. An advantage of this is that it may further reduce the likelihood of an electric shock and/or other related hazards.

Still another feature of the present invention is that the inventive changes are to the internal structure of the lamp and not to the exterior configuration. This allows for the immediate use of the present invention lamp in the lamp holders (and/or lamp sockets) found in many of the currently available light string sets without having to make lamp holder modifications.

Other features and their advantages will be apparent to those skilled in the art of lamp design from a careful reading of a Detailed Description Of The Invention accompanied by the following drawings.

### BRIEF DESCRIPTION OF THE SEVERAL VIEWS OF THE DRAWINGS

FIG. 1 is an illustration of the prior art miniature lamp.

FIG. 2A is a cross sectional view of the present invention showing the difference between the prior art and a preferred embodiment of the present invention.

FIG. 2B is a cross sectional view of the present invention, according to another preferred embodiment of the present invention.

FIG. 2C is a cross sectional view of the present invention, according to another preferred embodiment of the present invention.

FIG. 3 is a cross-sectional view of the lamp shown in FIG. 2A taken along lines 3-3.

FIG. 4A is a cross sectional view of the present invention showing the use of cleaving above the insulator, according to another preferred embodiment of the present invention.

FIG. 4B is a cross sectional view of the present invention showing the use of shorter conductors above the insulator, according to another preferred embodiment of the present invention.

### DETAILED DESCRIPTION OF THE INVENTION

The present invention is an improvement in the safety characteristics of a lamp. In particular, the improvements are associated with reducing, if not effectively eliminating, the occurrence of electrocution, serious electric shock, and/or fire hazards that may be caused by the crushing of the glass (or other material) envelope surrounding the internal components of the lamp. Generally, when the glass envelope of a lamp is crushed, the potentially “live” conducting wires, which are preferably Dumet wires, and the lamp filament, are directly exposed to the surrounding environment.

The lamp of the present invention is preferably a miniature lamp, of the type commonly found in light string sets including, but not limited to, those used to decorate Christmas trees. The lamp can be used in AC or DC powered strings, regardless of whether the lights are connected in series or in parallel with each other; however, the improvements in safety may be most beneficial to AC powered, series connected, lights string sets. The safety improvements include an improved location for the bypass shunt and the preferable use of a larger glass bead (or other material) insulator. The use of the insulator and/or the location of the bypass shunt, in combination with the lamp holder (which generally retains the bottom of a crushed lamp, and which generally is higher than the insulator when the bottom of the lamp and the holder are still interconnected) offers another safety feature, in that a protective area can be formed underneath the insulator, which increases the likelihood of the proper operation of the bypass shunt and decreases the likelihood of directly exposing full line-voltage to the environment. In another embodiment, an additional safety feature includes the use of potentially non-shorting conductors, which can be provided by cleaving the conductors along a portion of at least one of the conductors above the insulator, preferably close to where the conductor exits the insulator, or by limiting the length of the conductor above the insulator. These inventive changes also improve the safety characteristics of the lamp because they also reduce the availability of full line-voltage above the insulator.

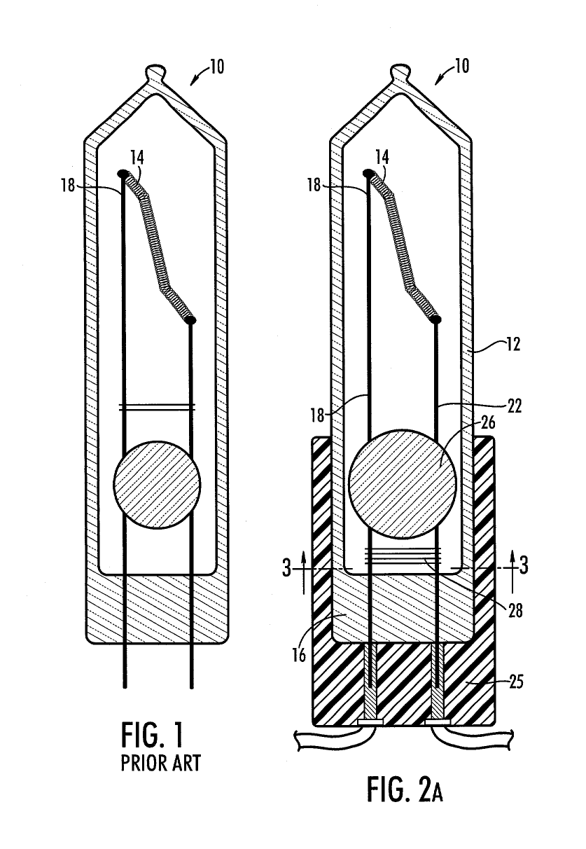

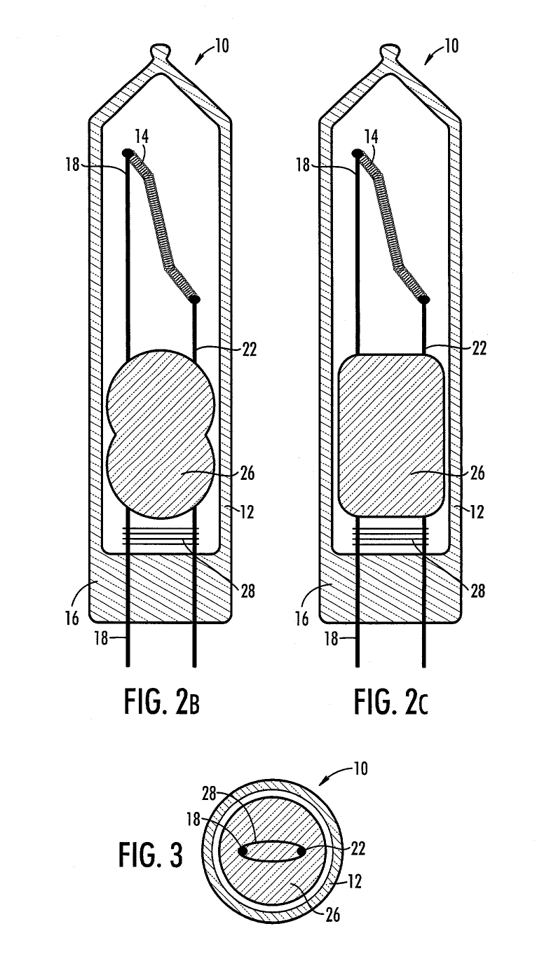

Other benefits are also provided by the present invention. For example, the improved dimensioning of the insulator provides for an improved placement of both conductors and the filament by better centering these components inside the glass envelope. This improved centering increases lamp life by reducing the number of filament particles condensing on the inside of the glass envelope, which is generally caused by keeping the filament further away from the inside of the glass envelope. This improved centering also keeps the exterior surface of the lamp much cooler, which may assist in preventing fires. Additionally, the use of a larger insulator, especially an oblong or a cylindrically-shaped insulator as shown in FIG. 2C, prevents the insulator and the conductors from twisting during lamp manufacture, which, in turn, may eliminate the occurrence of any problems associated with the twisting and, therefore, the stressing of the conductors. Furthermore, because the inventive changes to the lamp are to the lamp's interior components, the improved lamp of the present invention provides the benefit of being immediately capable of insertion into almost any existing light string lamp socket.

Referring now to FIGS. 2A-2C, and 3, the improved lamp is generally a indicated by reference number 10 and includes a sealed glass (or other suitable material) envelope 12. In the interior of the envelope 12 is a filament 14 connected at one end to a first conductor 18 and at another end to a second conductor 22. Also attached to the conductors 18 and 22 is a glass (or other material) insulator 26, which is used to support and to maintain the spacing between the conductors 18 and 22, which is needed to prevent them from touching and, therefore, short circuiting. This spacing is also important for ensuring the proper operation of the bypass shunt 28, e.g., if one or both of the conductors 18 and 22 become deformed or bent away from their normal position (to the extent that they no longer make contact with the bypass shunt 28) the bypass shunt 28 could be prevented from working. The conductors 18 and 22 extend through and are supported by the sealed bottom wall 16 of the envelope 12 where they are generally connected to a source of electrical potential through the insertion of the lamp 10 into one of the lamp holders 25 of a light string set (not shown). Generally, the lamp is manufactured by using standard miniature lamp fabrication machines that have been modified to construct the inventive present invention lamp. These machines are instructed to fabricate and assemble the various component parts including, but not limited to, cutting and assembling the conductors 18 and 22 and the filament 14, and then attaching an insulator 26 and bypass shunt 28 to the conductors 18 and 22 (as shown by the figures). Afterwards, these components (14, 18, 22, 26 and 28) are inserted into a glass tube, and then by heating and feeding additional glass feed stock into and onto the conductors 18 and 22 and to the bottom of the glass tube, a bottom for the envelope 16 is formed. With the exception of the glass (or other material) used to make the insulator 26, the glass on the bottom of the envelope 16 is the thickest piece of material used in the lamp 10. After manufacturing, the bypass shunt 28 is preferably located between the insulator 26 and the bottom of the envelope 16 in an area that is in the range of about 1-20 mm²; however, any other suitable size area that can offer protection to the bypass shunt 28 can be used as well.

The present invention lamp 10 provides improvements to miniature lamp safety because of, but not limited to, the inclusion of the following lamp features: locating the bypass shunt 28 in a small space below the insulator 26; using a preferably enlarged insulator 26; the protective combination of the insulator 26 with an attached lamp holder 25; and using only short conductor 18 and 22 lengths below the insulator 26. These features, by themselves and/or in combination, are able to improve safety because they increase the probability that the bypass shunt 28 will properly operate, which, in turn, decreases the likelihood of directly exposing the user to full line-voltage; thereby, reducing the potential for electrocution, serious electrical shocks and fire hazards.

Preferably, the bypass shunt 28 is fabricated of an aluminum oxide or some other oxidizable electrically conductive material that is wrapped around the conductors 18 and 22 and is able to shunt the filament 14 after the filament 14 open circuits due to age, i.e., the filament burns out, or due to a crushing force causing the filament 14 to break. The bypass shunt 28 also adds tot he safety features of the present inventive lamp 10 by increasing the number of turns that the bypass shunt 28 is wrapped around the conductors 18 and 22. Generally, the prior art wraps shunt material around its conductors two times; however, the present invention wraps its bypass shunt 28 at least 2.5 times, and, preferably, 3.5 times around the conductors 18 and 22. This extra wrapping increases the probability that an effective shunting action will occur, even in the event that the lamp 10 becomes so crushed that the portions of the conductors 18 and 22 below the insulator 26 are deformed. As mentioned, even though the bypass shunt 28 is preferably made of aluminum oxide or some other similar type of oxidizable metal, and/or the bypass shunt 28 is preferably a wire that can be wrapped around the conductors 18 and 22, this is not the only type of material, the only type of shunt, and/or the only method for connecting the shunt to the conductors, that can be used in the present invention; therefore, any other suitable material, type of shunt, and/or connection method, capable of withstanding the stresses associated with miniature lamps can be used as well. Additionally, the conductors 18 and 22 are preferably made from Dumet wire and the filament 14 is preferably made of tungsten; however, any other suitable conductor material and/or filament material can be used as well.

Referring to FIGS. 2A through 2C, the insulator 26 can be spherically shaped, as shown in FIG. 2A, it can formed into a overlapping double spheroid, as shown in FIG. 2B, or it is, preferably, cylindrical or oblong, as shown in FIG. 2C; however, while these are the preferred shapes any other suitable shape and/or dimensioning that is capable of being inserted into the envelope 12 can be used just as well. As previously mentioned, the insulator 26 is preferably fabricated from glass; however, any other suitable insulator material can also be used.

As an example, but not as a limitation, during normal operation of a lamp 10 in a series connected 50 lamp light string powered by a 120 VAC source, there is normally about 2.5 VAC being dropped across each lamp in the string and, because of this low voltage drop, the oxide coating on the bypass shunt 28 will not conduct electricity; therefore, the normal circuit path in the lamp 10 for electrical current flow will be comprised of conductor 18, filament 14, and conductor 22. However, when the filament 14 open circuits by becoming damaged due to a crushing of the lamp envelope 12, by burning out, and/or by some cause of becoming open circuited, the full line-voltage, i.e., 120 VAC, is applied across the faulty lamp. This voltage is greater than the breakdown voltage of the oxide coating, which generally requires a voltage greater than about 35 volts for aluminum oxide, causing the bypass shunt 28 to become electrically conductive; thereby, shorting the first conductor 18 and the second conductor 22 together below the insulator 26. This provides the user with several advantages including, but not limited to: minimizing the possibility of a electric shock due to contact with the exposed conductors 18 and 22; and keeping the remaining lights energized, which causes the voltage drop across the faulty lamp to be only about 2.5 VAC instead of 120 VAC, drastically reducing the magnitude of any remaining shock hazard.

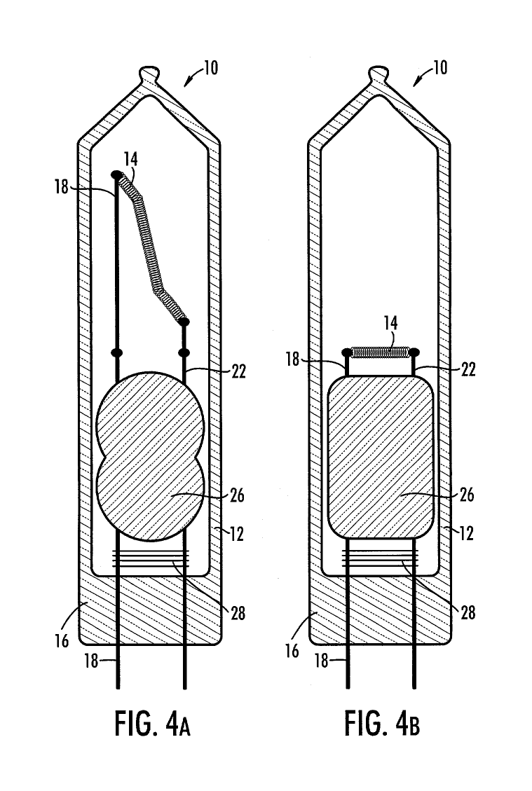

In another embodiment, which is shown in FIG. 4A, at least one of the conductors 18 and/or 22 is cleaved so that damage to the lamp envelope 12 and/or to the conductors 18 and/or 22 themselves will cause one or both of the conductors 18 and/or 22 to break free from the other portion of the conductor 18 and/or 22 that is below the cleave. By breaking apart in this manner, the possibility of exposing fall line-voltage above the insulator 26 to the user and/or the environment should be minimized. Another embodiment, which is shown in FIG. 4B, shows another manner in which to minimize the possibility of exposing full line-voltage above the insulator 26. In this embodiment, the length of at least one of the conductors 18 and 22 is shortened to the extent that the total length of the conductors 18 and 22 above the insulator 26 is less than the length required for the conductors 18 and 22 to directly touch each other.

While conductor cleaving was shown with a double-bead insulator embodiment, and conductor shortening was shown with a cylindrical bead insulator, it is important to note that these, along with the other preferred embodiments of the present invention were disclosed by way of example and not by way of limitation. It is intended that the scope of the present invention include all modifications that incorporate its principal design features, and that the scope and limitations of the present invention are to be determined by the scope of the appended claims and their equivalents. It also should be understood, therefore, that the inventive concepts herein described are interchangeable and/or they can be used together in still other permutations of the present invention, and that other modifications and substitutions will be apparent to those skilled in the art of lamp manufacture from the foregoing description of the preferred embodiments without departing from the spirit or scope of the present invention.

What is claimed is:

1. A lamp, comprising:
(a) an envelope having an interior, said interior having an interior top and an opposing interior bottom, said interior having an interior length between said interior top and said interior bottom, said envelope having a maximum inner width transverse to said interior length, said envelope having a maximum envelope exterior length;
(b) a first conductor having a first end and an opposing second end, said second end extending through said envelope;
(c) a filament in electrical connection with said first conductor having a filament first end and an opposing filament second end;
(d) a second conductor having a second conductor first end and an opposing second conductor second end, said second conductor in electrical connection with said filament, said second conductor second end extending through said envelope;
(e) an insulator bead having an insulator bead top and an opposing insulator bead bottom, said insulator bead holding said first conductor and said second conductor in a spaced-apart relation, said insulator bead located within said interior of said envelope so that said insulator bead bottom is proximal to said interior bottom and said insulator bead top is distal from said interior bottom, said insulator bead having an insulator bead longitudinal length running between said insulator bead top and said insulator bead bottom, said insulator bead having a maximum insulator bead width running transverse to said insulator bead longitudinal length; and
(f) a bypass shunt located within said interior of said envelope, said bypass shunt attached to said first conductor and said second conductor below said insulator bead and above said bottom of said envelope interior, wherein, upon an open-circuit condition being created above said insulator bead, said bypass shunt creates a current path below said insulator bead for directing current through said first conductor and said second conductor by said current path.

2. The lamp as rescited in claim 1, wherein said insulator bead is made of glass.

3. The lamp as recited in claim 1, wherein said insulator bead is made of material selected from a group consisting of plastic and ceramic.

4. The lamp as recited in claim 1, wherein said insulator bead is spherically shaped.

5. The lamp as recited in claim 1, wherein said insulator bead is spheroidally shaped.

6. The lamp as recited in claim 1, wherein said insulator bead has a double-spherical shape.

7. The lamp as recited in claim 1, wherein said insulator bead is cylindrically shaped.

8. The lamp as recited in claim 1, wherein said insulator bead has an oblong shape.

9. The lamp as recited in claim 1, wherein said maximum insulator bead width is in the range of about 50% of said maximum inner width of said envelope to about 100% of said maximum inner width of said envelope.

10. The lamp is recited in claim 1, wherein said maximum insulator bead width is in the range of about 60% of said maximum inner width of said envelope to about 95% of said maximum inner width of said envelope.

11. The lamp as recited in claim 1, wherein said maximum insulator bead width is in the range of about 75% of said maximum inner width of said envelope to about 100% of said maximum inner width of said envelope.

12. The lamp as recited in claim 1, wherein said bypass shunt is made of an oxidized electrically conductive material that is wrapped around said first conductor and said second conductor at least 2.5 times.

13. The lamp as recited in claim 1, wherein said bypass shunt is made of an oxidized electrically conductive material that is wrapped around said first conductor and said second conductor at least 3.5 times.

14. The lamp as recited in claim 1, wherein said first conductor and said second conductor are cleaved above said insulator bead top.

15. The lamp as recited in claim 1, wherein said first conductor and said second conductor are dimensioned so that they cannot directly contact each other and cause a short circuit above said insulator bead top.

16. The lamp as recited in claim 1, wherein said envelope is dimensioned so that it has a maximum envelope exterior length no larger then 2.5 inches.

17. The lamp as recited in claim 1, wherein said insulator bead longitudinal length is no smaller than said maximum insulator bead width.

18. The lamp as recited in claim 1, further comprising a lamp holder having a lamp holder top, said lamp holder for carrying said envelope and for providing power to said filament through said first conductor and said second conductor, wherein said insulator bead top is about level with said lamp holder top when said envelope is inserted into said lamp holder.

19. The method for making a miniature safety lamp, comprising the steps of:
(a) providing a miniature lamp glass tube, said glass tube having an interior, said glass tube having a glass tube bottom and an opposing glass tube top;
(b) cutting two conductor segments, each of said two conductor segments having a top end and a bottom end;
(c) cutting a filament segment, said filament segment having a first end and an opposing second end;
(d) attaching said first end of said filament segment to said top end of one of said two conductor segments and attaching said second end of said filament segment to said top end of the other of said two conductor segments;
(e) forming and attaching an insulator bead to the conductors, said insulator bead having an insulator bead filament side and an opposing insulator bead bottom side, said insulator bead filament side being proximal to said filament when said filament is attached to said two conductors segments and said insulator bead bottom side being distal to said filament when said filament is attached to said two conductors segments;
(f) attaching a bypass shunt below said insulator bead bottom side;
(g) inserting said two conductors segment, said filament, said bypass shunt, and said insulator bead into said interior of said glass tube; and
(h) forming a bottom for said glass tube by heating and feeding glass feed stock into and onto said two conductor segments and to said glass tube bottom, wherein a space of less than about 20 mm² is formed inside said envelope interior between said insulator bead bottom and said glass tube bottom.

20. A miniature safety lamp, comprising:
(a) an envelope having an interior, said interior having a sealed interior top and an opposing sealed interior bottom, said interior having a longitudinal length running between said sealed interior top and said sealed interior bottom, said envelope having a maximum inner width transverse to said longitudinal length of said interior;
(b) a first conductor having a first end and an opposing second end, said second end extending through said sealed interior bottom;
(c) a filament in electrical connection with said first conductor having a filament first end and an opposing filament second end;
(d) a second conductor having a second conductor first end and an opposing second conductor second end, said second conductor in electrical connection with said filament, said second conductor second end extending through said sealed interior bottom;
(e) an insulator bead having an insulator bead top and an opposing insulator bead bottom, said insulator bead holding said first conductor and said second conductor in a spaced-apart relation, said insulator bead located within said interior of said envelope so that said insulator bead bottom is proximal to said sealed interior bottom and said insulator bead top is distal from said sealed interior bottom, said insulator bead having a maximum insulator bead width running transverse to said longitudinal length of said interior, said maximum insulator bead width is in the range of about 70% to about 100% of said maximum inner width of said envelope; and
(f) a bypass shunt located within said interior of said envelope, said bypass shunt attached to said first conductor and to said second conductor below said insulator bead and above said sealed interior bottom, wherein, upon an open-circuit condition being created above said insulator bead, said bypass shunt creates a current path below said insulator bead for directing current through said first conductor and said second conductor by said current path.
